(19) United States
(12) Patent Application Publication
(10) Pub. No.: US 2026/0264091 A1
(43) Pub. Date: Sep. 10, 2026

(54) Cutting device, especially for meat grinders

(71) Applicant: Lumbeck & Wolter GmbH & Co. KG, Wuppertal (DE)

(72) Inventors: Udo Back, Münnerstadt/Reichenbach (DE); Fabian Döring, Wuppertal (DE)

(73) Assignee: Lumbeck & Wolter GmbH & Co. KG, Wuppertal (DE)

(21) Appl. No.: 19/554,714

(22) Filed: Mar. 3, 2026

(30) Foreign Application Priority Data
Mar. 4, 2025 (DE) 202025101147.6

(51) Int. Cl. B02C 18/36

(52) U.S. Cl. CPC B02C 18/362

(57) ABSTRACT

The invention relates to a cutting device (10), in particular for meat grinders, with an outer ring (20) having an inner circumference (21) and with a rotatably driven knife (30) that can be detachably arranged within the outer ring (20) and has one or more outer ends (35) with which it can interact with the inner circumference (21) of the outer ring (20). The invention provides that the knife (30) has a groove (36) at each of its outer ends (35), that the outer ring (20) has a circumferential rib (22) on its inner circumference (21), which is formed integrally with the outer ring (20), and that the knife (30) is arranged in the outer ring (20) such that the circumferential rib (22) of the outer ring (20) engages in the groove (36) at the outer ends (35) of the knife (30), so that the knife (30) is rotatably held in the outer ring (20), that the outer ring (20) or the rib (22) has at least one recess (23), and that for mounting the knife (30) in the outer ring (20), the recess (23) on the outer ring (20) or the rib (22) is connected with a several of the outer ends (35) of the knife (30) are aligned and at least one flank (38) of the groove (36) at the outer end (35) of the knife (30) overcomes the rib (22) on the inner circumference (21) of the outer ring (20).

The invention relates to a cutting device, especially for use in a meat grinder. Such cutting devices are used particularly in the meat processing industry, but also in other areas of food preparation and in other industries.

### BACKGROUND

During operation of the meat grinder, the material to be ground is pressed against the cutting set, which in a meat grinder typically consists of at least two perforated discs and at least one blade, by means of a screw conveyor or other conveying device. Particularly when processing heavy or frozen material, high pressures can occur. The knives used for this purpose, also known as HD (Heavy Duty) knives, must withstand these stresses and exhibit minimal wear.

To minimize the wear of knives in meat grinders, even under high loads, so-called outer or spacer rings are used, in which the knife operates. The outer ring absorbs pressure from the blades of the knife and dissipates it, thus reducing wear. This has the advantage that the blades of the knife need sharpening less frequently and that less abrasion and wear from the knife is unintentionally processed into the food.

The knife is mounted rotatably in the outer ring, which is fixed in place.

There are various ways to keep the knife rotatable within the outer ring. After a certain period, however, the knife must be removed from the cutting set for sharpening. If the knife and the outer ring are accidentally or intentionally separated from each other during this process, both parts must then be reattached. Over time, the knife and its corresponding outer ring wear into place with each other. If the knife is then mounted on a different outer ring, damage can occur during operation of the meat grinder. For example, the knife could break. This necessitates an expensive replacement and results in unnecessary downtime for the machine during repairs.

One way to secure a knife to the outer ring is by soldering, brazing or welding. This is time-consuming, however, and is extremely cumbersome if the knife or outer ring needs to be replaced.

DE202006019453U1 describes a ring knife for mounting in a spacer ring. To hold the knife in the ring, threaded studs are provided, which can be inserted from the outside through the outer ring into a thread located in the knife. This assembly is quite complex. If the knife and outer ring are to be separated, the threaded studs can be lost.

DE202015007092U1 describes a knife with a spacer ring and blades of the knife. The knife is held in the spacer ring by means of a bayonet fitting. Here, there is a particular risk, especially during cleaning or sharpening, that the knife will detach from the spacer ring and then be mixed up.

German patent DE202016103109U1 also describes a heavy-duty knife with a spacer ring and the knife is ring-shaped. Here, the ring-shaped knife has a circumferential groove, while the spacer ring has several projections that can engage in this groove. For assembly, the knife is inserted into the spacer ring and then twisted to prevent it from coming loose. However, since the knife is held rotatably in the ring, twisting it can accidentally disassemble the knife from the ring, leading to the problems already described.

To avoid the aforementioned disadvantages, German patent DE202013103989U proposes an outer ring with an opening at one point. This opening can then be manually or mechanically bent open to insert the knife into the outer ring. Here, too, a rib engages in a groove on the knife. However, if a ring blade is used, which is advantageous under high loads because it is more stable than a blade without a ring, extremely high forces must be overcome on the outer ring to insert the ring blade into the outer ring. Depending on the size, this can be difficult or even impossible. Furthermore, the ring may deform during the bending process and then become unusable.

It would be very helpful if a way could be devised to avoid the aforementioned disadvantages and to provide a cutting device on which a knife can be retained on an outer ring, which prevents accidental disassembly of the knife from the outer ring, and which allows for easy assembly and disassembly of the knife and outer ring without the use of additional components.

### SUMMARY OF THE INVENTION

In an embodiment of the invention, blades of a knife each have a groove at their outer end, while the outer ring has a circumferential rib. The knife is positioned on the outer ring such that the circumferential rib of the outer ring engages in the grooves at the outer ends of the blades. This allows the knife to rotate freely on the outer ring. When the meat grinder is in operation, the knife rotates while the outer ring remains stationary within the grinder housing. The outer ring and/or the rib have at least one recess, while at least one of the knife blades has a corresponding recess that engages with the at least one recess. When the knife is being mounted in the outer ring, the blade recesses and corresponding ring recesses are aligned. The knife is then subjected to a force sufficient to overcome the rib on the inner circumference of the outer ring, thus securing the knife in the outer ring. This can also be achieved by heating the outer ring slightly to allow it to expand. In this way, the knife is held securely but releasably in the outer ring. To remove the knife from the outer ring, the knife must be realigned and subjected to sufficient force to overcome the rib on the outer ring. Heating the outer ring can be helpful in this process. It is particularly advantageous if the outer ring can be heated without being damaged or undergoing any structural changes. Alternatively, the knife can be cooled to cause it to contract.

In a preferred embodiment, the counter-recess on the blade (or blades) is designed as a shallower flank. However, this flank is still high enough that it cannot overcome the rib on the inner circumference of the outer ring without considerable force, as it protrudes above it. In a preferred embodiment, this flank has a chamfer or other type of material removal that helps it overcome the rib more easily. Besides a chamfer, a rounded edge, a bevel, or a similar material removal feature may also be present. When the knife is then subjected to this force, the flank can overcome the rib, and the knife is securely held on the outer ring without being accidentally released. To simplify this process, the outer ring can be heated to cause it to expand, or the knife can be cooled, as mentioned.

Advantageously, the outer ring has a mounting side from which the knife can be mounted in the outer ring. The rib on the mounting side may have a material reduction, such as a chamfer, bevel, rounding, or similar feature, to facilitate the passage of the workpiece over the rib. If the rib has a recess, additional material reduction may be provided in the area of the recess. Naturally, it is also possible for the rib to have a material reduction on both sides. The mounting side is preferably the front of the outer ring. To facilitate the installation of the knife into the outer ring, the blades may have different radial extents. The tallest knives are inserted into the outer ring first, and the shorter ones last, usually in the area of the recesses in the rib. The number of knives and recesses depends on the specific application. It is also possible for the rib to have no recesses, but for the recess to be created by the shorter height of the knives. In this case, the shorter height acts as the recess. Alternatively, recesses can be provided on the outer ring, the rib, and the blade.

If the knife is mounted on the outer ring, it is advantageously held in a form-fitting and rotatable manner. The desirable result is that the knife cannot be mounted or dismounted from the outer ring without tools. This prevents the knife from being unintentionally removed during installation, cleaning, or sharpening, and then remounted on the wrong outer ring, potentially damaging it during operation of the meat grinder.

Depending on the application, the blades of the knife can form a cross-shape or a star-shape. Other designs are also conceivable. The cutting edges on the blades can be on one or both sides thereof. Again, the chosen design depends on the application.

In a particularly advantageous embodiment, the outer ring is sized to be a few hundredths of a millimeter thicker than the thickness of the blades, for example two or four or six hundredths of a millimeter thicker. This difference in thickness can range from a few hundredths of a millimeter to a tenth of a millimeter. The outer ring corresponding to the knife is clamped between the two perforated discs during assembly of the complete cutting set, allowing the cutting motion to occur. This difference in thickness reduces the amount of scraping or scratching of the knife against the adjacent perforated discs. The knife itself can move freely within the outer ring between the two perforated discs. This allows the outer ring to very effectively absorb the pressure that would otherwise act on the knife, thus reducing blade wear.

If the knife is marked to indicate which blades have the counter-recess, disassembly of the knife from the outer ring is particularly easy, as it is then clear how the knife must be oriented within the outer ring for removal. If all blades have a counter-recess, no marking is necessary.

Further advantages and embodiments will become apparent from the following description, and the drawings.

### DESCRIPTION OF THE DRAWING

The invention is illustrated in three exemplary embodiments in a drawing in several figures.

FIG. 1 shows a cutting device according to a first embodiment of the invention, in a perspective front view,

FIG. 2 shows the cutting device from FIG. 1 in a front view,

FIG. 3 shows the cutting device from FIGS. 1 and 2 in a side view, and

FIG. 4 shows the cutting device from FIGS. 1 to 3 in section.

FIG. 5 shows a cutting device according to a second embodiment of the invention, in a front view,

FIG. 6 shows the cutting device from FIG. 5 in section,

FIG. 7 shows the cutting device from FIGS. 5 and 6 in a further section, and

FIG. 8 shows the knife from the cutting device from FIGS. 5 to 7 in a side view.

FIG. 9 shows a cutting device according to a third embodiment of the invention, in a front view,

FIG. 10 shows the cutting device from FIG. 9, in a perspective front view,

FIG. 11 shows the cutting device from FIGS. 9 and 10 in section, and

FIG. 12 shows the knife from the cutting device shown in FIGS. 9 to 11 in side view.

### DETAILED DESCRIPTION

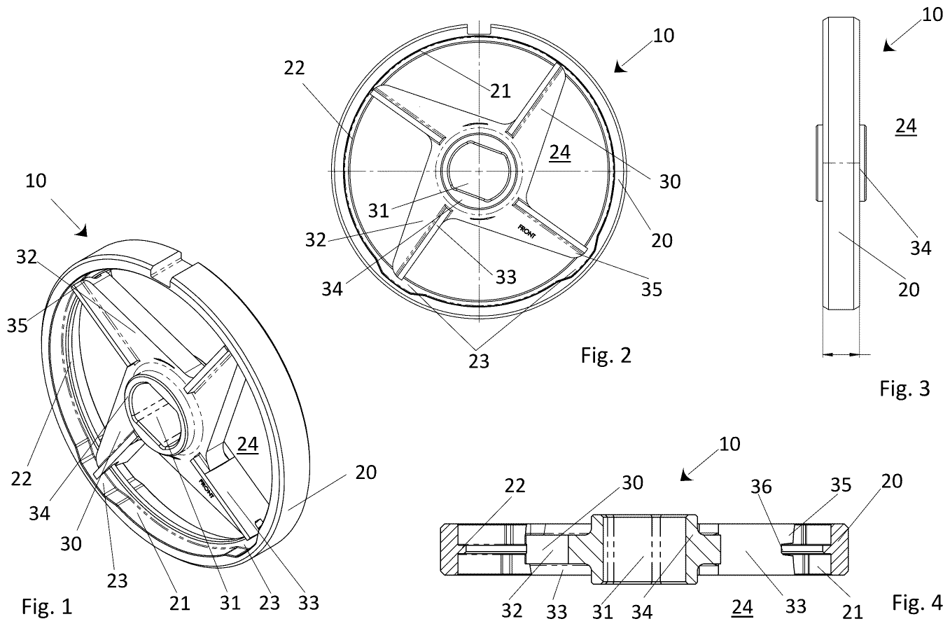

FIGS. 1 to 4 show a knife 30 according to the invention in an outer ring 20. The knife 30 is rotatably and driveably mounted in the outer ring 20. A radial central hub 34 with a bore 31 is provided on the knife 30, through which the drive of the knife 30 can be enabled. The knife 30 has four blades 32, each of which extends radially outwards from the vicinity of the hub 34 and each has a groove 36 at its outer end 35, as shown in FIG. 4. The blades 32 are arranged in a cross shape. Cutting edges 33 are provided on each blade 32, which, together with at least one perforated disc (not shown), produce the cutting action of the meat grinder.

The outer ends 35 of the blades 32 each have a groove 36 into which a rib 22 on the inner circumference 21 of the outer ring 20 engages. This allows the knife 30 to be rotatably mounted in the outer ring 20. This is particularly evident in the sectional drawing in FIGS. 4 and 8.

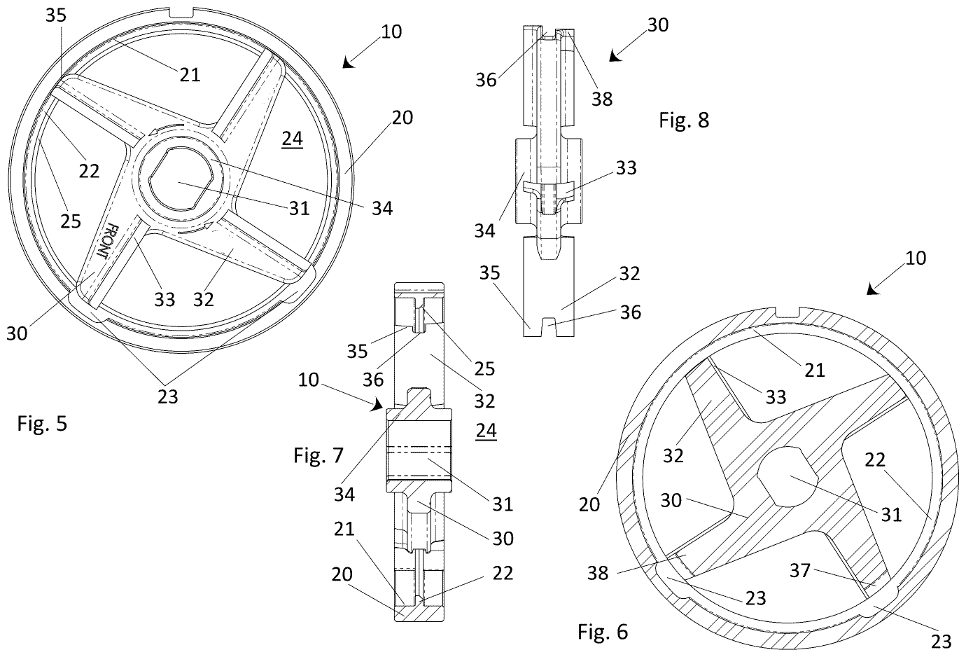

Turning now to FIGS. 5-8, FIG. 5 shows two recesses 23 in the area of the rib 22 on the inner circumference 21 of the outer ring 20. The sectional drawing in FIG. 6 shows that the two blades 32, which interact with these recesses 23, have corresponding recesses 37. Additionally, the rib 22 in this area has a chamfer 25, which is a material removal feature, as shown in FIG. 7. The combination of recess 23, corresponding recess 37, and chamfer 25 allows the knife 30 to be mounted or dismounted in the outer ring 20. For this, the knife 30 must be correctly aligned in the outer ring 20, and the outer ring 20 must be heated so that it expands slightly. Then, by applying force to the knife 30, it can be inserted into the outer ring 20 from the mounting side 24. As the outer ring 20 cools, it contracts again, thus preventing the knife 30 from being accidentally removed.

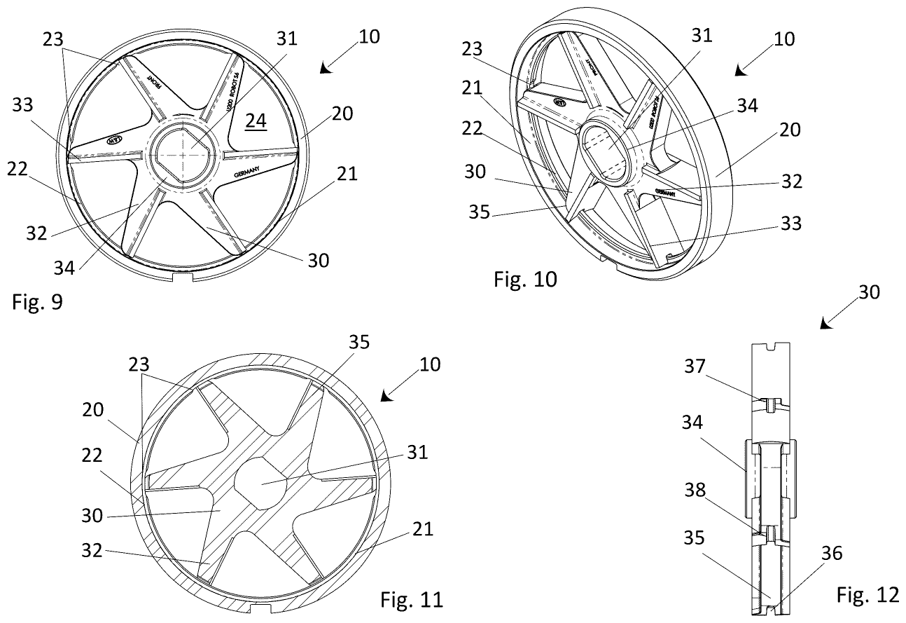

A further embodiment of the cutting device according to the invention is shown in FIGS. 9 to 12. Here, the rib 22 has several recesses 23 that interact with counter-recesses 37 at the outer ends 35 of the blades 32 to facilitate the mounting and removal of the knife 30 in the outer ring 20.

The knife 30 shown here has six blades 32, four of which have a counter-recess 37. Correspondingly, the rib 22 also has four recesses 23. The number of recesses 23 and counter-recesses 37 depends on the specific application and the number of blades 32.

When mounting the knife 30 in the outer ring 20, the two blades 32, which do not have a counter-recess 37, are first placed on the rib with their groove 36 at the outer end 35, such that the outer ends 35 of the blades 32 with their counter-recess 37 are arranged near the recesses 23 in the rib 22. When force is applied, one flank 38 of the outer ends 35 of the blades 32 then overcomes the rib 22 in the area of the recesses 23. The rib 22 can also have a material removal feature in the area of the recesses 23, such as a chamfer, a bevel, or the like, to facilitate the overcoming of the rib 22 by one flank 38. The one flank 38 with the counter-recess 37 is visible in FIG. 12. Furthermore, it is particularly evident from FIGS. 9 and 11 that the blades 32 are of different lengths. This is a further advantage when assembling and disassembling the blades 32 on the outer ring 20.

The knife 30 shown in FIGS. 9 to 12 has six blades 32. However, the number of blades 32 is variable and depends on the specific application.

Finally, it should be noted that the embodiments shown here are merely exemplary realizations of the invention. The invention is not limited to these examples. Modifications and variations are possible. For instance, the knife can have more or fewer blades and more or fewer cutting edges. The design of the cutting edges can also vary. Furthermore, the groove on the outer ring can be interrupted or comprised of several sections. The exact design depends on the specific application.

### REFERENCE LIST

10 Cutting device
20 Outer ring
21 Inner circumference of 20
22 Rib on 21
23 Recess on 20 or on 22
24 Mounting side of 20
25 Chamfer on 22
30 Knife
31 Bore
32 Blade
33 Cutting edge
34 Hub
35 Outer end of 32
36 Groove
37 Counter recess
38 One flank of 36

1. A cutting device (10), in particular for meat grinders,
with an outer ring (20) having an inner circumference (21) and with a rotatably drivable knife (30) detachably arranged within the outer ring (20), the knife having one or more outer ends (35) with which it can interact with the inner circumference (21) of the outer ring (20),
characterized in that,
the knife (30) has a groove (36) at each of its outer ends (35),
the outer ring (20) having a circumferential rib (22) on its inner circumference (21), which is formed integrally with the outer ring (20), and the knife (30) is arranged in the outer ring (20) such that the circumferential rib (22) of the outer ring (20) engages in the groove (36) on the outer ends (35) of the knife (30), so that the knife (30) is rotatably mounted in the outer ring (20), thereby defining a mounted state thereof,
the outer ring (20) or the rib (22) having at least one recess (23), such that, for mounting the knife (30) in the outer ring (20), the recess (23) on the outer ring (20) or the rib (22) is aligned with one or more of the outer ends (35) of the knife (30), and at least one flank (38) of the groove (36) at the outer end (35) of the knife (30) engages the rib (22) on the inner circumference (21) of the outer ring (20).

2. The cutting device (10) according to claim 1, characterized in that the knife (30) has a central hub (34) provided with a bore (31) for rotationally fixed mounting during rotation in one direction, and several blades (32) with cutting edges (33) arranged around the hub (34) and extending outwards from it, the outer ends (35) of which form the outer ends of the knife (30).

3. The cutting device (10) according to claim 1, characterized in that at least one of the blades (32) comprises at least one counter-recess (37) at its outer end (35) which can be brought into operative contact with the at least one recess (23).

4. The cutting device (10) according to claim 3, characterized in that the counter-recess (37) on the at least one blade (32) is designed as a flatter flank (38) which, however, still projects beyond the rib (22) on the inner circumference (21) of the outer ring (20).

5. The cutting device (10) according to claim 2, characterized in that the blades (32) are arranged in a cross or star shape.

6. The cutting device (10) according to claim 2, characterized in that the cutting edges (33) are formed on both sides of the blades (32).

7. The cutting device (10) according to claim 2, characterized in that the outer ring (20) is at least two hundredths of a millimeter thicker than the cutting edges (33) of the blades (32).

8. The cutting device (10) according to claim 1, characterized in that, in the mounted state of the knife (30), it is rotatably held on the outer ring (20) by a positive-locking connection, and that the knife (30) cannot be inserted into or removed from the outer ring (20) without tools.

9. The cutting device (10) according to claim 1, characterized in that, for mounting the knife (30), the outer ring (20) is disposed to be heated and thus expanded, and then, by application of a force to the knife (30), is disposed to permit mounting of the blade into the outer ring (20).

10. The cutting device (10) according to claim 1, characterized in that the outer ring (20) has a mounting side (24) from which the knife (30) can be mounted in the outer ring (20).

11. The cutting device (10) according to claim 10, characterized in that the rib (22) on the mounting side (24) has a material removal feature (25), namely a chamfer, bevel, or rounding.
